(19) United States
(12) Patent Application Publication
(10) Pub. No.: US 2006/0021270 A1
(43) Pub. Date: Feb. 2, 2006

(54) Method of private labeling a garment

(76) Inventor: Patrick B. Hanley, Richville, MN (US)

Correspondence Address: SCHROEDER & SIEGFRIED, P.A., 15600 WAYZATA BOULEVARD, SUITE 200, WAYZATA, MN, 55391, US

(21) Appl. No.: 10/911,158

(22) Filed: Aug. 2, 2004

(51) Int. Cl. D05B 3/12; A41D 27/08; D05B 23/00; G09F 3/10

(52) U.S. Cl. 40/638; 2/246; 112/104; 112/475.09

(57) ABSTRACT

An improved method for private labeling of garments which eliminates tedious and cost intensive sewing operations, wherein the original manufacturer's brand label is removed and replaced with a pressure-sensitive adhesive private label that is secured to the original care instruction label in such manner as not to obstruct the readability thereof. The private label is produced from a durable printable woven fabric that is washable, and carries a pressure-sensitive adhesive strip that adheres to non-printed portions of the care instruction label so as to form a movable flap thereover. This method is particularly useful for private labeling smaller quantities of garments, where labor intensive sewing operations are cost prohibitive.

### BACKGROUND OF THE INVENTION

The present invention is related generally to the art of garment labeling, and more particularly to an improved method for replacing original manufacturer brand labels with private labels of garment decorators.

It has been a long-standing and popular practice for companies and other organizations and/or associations to engage the services of screen printers and embroiderers, known in the trade as “garment decorators”, to decorate various articles of clothing, such as T-shirts, sweatshirts, etc., with company names, logos, and the like. In order to fill such orders, the garment decorator will typically purchase “off-the-shelf” pre-manufactured garments to decorate. However, unless large quantities of garments are ordered, private labels (i.e., labels bearing the decorator's own company name, logo and contact information) will not generally be sewn into the garments being purchased. Thus, for smaller orders, which is quite often the case, the decorator is left with a final product bearing the original manufacturer's brand label, with no reasonable means to advertise its own business.

Currently, the only known method available to decorators who wish to private label smaller quantities of pre-manufactured garments is to cut the original manufacturer's brand label out of the garment (leaving the care instruction label) and sew in their own woven or printed private label. This process is extremely laborious and inefficient; it involves not only removing the original brand label, but also requires costly time, equipment and people skilled enough to sew in a new private label. Since smaller orders for garment decoration are now more often the norm than the exception, there is a distinct need to provide a means by which the decorator can more effectively and economically advertise its business through private labeling. It is with this in mind that I have developed a new and effective way of applying a private label to a garment which does not require such additional time consuming and labor intensive sewing operations.

### BRIEF SUMMARY OF THE INVENTION

In accordance with the present invention, an improved method is proposed for private labeling of pre-manufactured garments which requires no minimum garment quantity, and which is less time consuming and labor intensive than previous methods known in the art. Toward this end, it is contemplated that the original manufacturer's brand label be removed from the garment and an adhesive-backed private label be produced and applied to the garment's care instruction label in accordance with the method described herein.

The original sewn-in brand label of the pre-manufactured garment must first be removed. This may be accomplished by either cutting the label from the garment, or alternatively providing the pre-manufactured garment with a brand label having a perforated tear line that allows the label to be torn from the garment. Removal of the original brand label may then be effected simply by grasping the free portion of the label and pulling it to separate it from its sewn-in edge.

The replacement private label, which bears the decorator's private labeling indicia, is preferably constructed of a flexible, yet durable, printable woven fabric, and carries a pressure-sensitive adhesive strip on its rear face along its top edge. The adhesive strip also preferably has a non-stick peel-off backing that may be readily removed to expose the adhesive and simplify application of the private label to the garment. The private label, adhesive strip, and printing ink utilized must be water-resistant and washable. As used herein and throughout the appended claims, the term “washable” is intended to connote that the subject material is capable of withstanding at least about 20-30 home laundering cycles without serious degradation of the integrity of the material.

The remaining care instruction label of the garment, which is also typically sewn into the garment, provides a durable and flat substrate to which the new private label may be secured. Since most care instruction labels of pre-manufactured garments have a non-printed border adjacent their sewn-in edge, this provides an area to which the adhesive strip of the private label may adhere without obstructing the printed care instructions borne on the label. Moreover, most care instruction labels are also of generally uniform width, so the decorator may produce large quantities of standard sized private labels and use the same printed label for multiple job orders.

In order to secure the private label to the care instruction label, the adhesive strip of the private label is positioned over the non-printed border region of the original care instruction label and the non-stick backing material is removed. Then the private label is firmly pressed against the care instruction label, thereby securely bonding the two together and essentially creating a “private label” flap that lays over the top of the care instruction label. Thus, with relative ease, the free end portion of the private label may be lifted away from the care instruction label for easy access and viewing of the garment's care instructions.

This process may be effectively used to private label small quantities of garments, as well as large quantities. It eliminates the cost prohibitive and labor intensive sewing operations required for prior sewn-in private labels, and given the generally standard sizing of care instruction labels, garment decorators may mass produce their private labels and use the same on multiple job orders and for many different garments. This will significantly increase the ability of the garment decorators to advertise their services, which has heretofore been severely restricted.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1A is a partial front plan view of the upper portion of a pre-manufactured T-shirt showing the original brand and care instruction labels sewn therein;

FIG. 1B is a partial front plan view of the upper portion of another typical pre-manufactured garment showing the original brand and care instruction labels sewn therein;

FIG. 2 is a perspective view of the adhesively-backed private label utilized in the implementation of the private labeling process in accordance with my invention.

FIG. 3 is an enlarged front elevational view of the labeled portion of the garment shown in FIG. 1B, showing one preferred manner of removal of the original brand label and the appropriate placement of the new private label in accordance with my invention.

FIG. 4 is an enlarged front elevational view of the labeled portion of the garment shown in FIG. 1B, showing the original brand label removed and the new private label adhesively secured to the care instruction label in accordance with my invention.

### DETAILED DESCRIPTION OF THE INVENTION

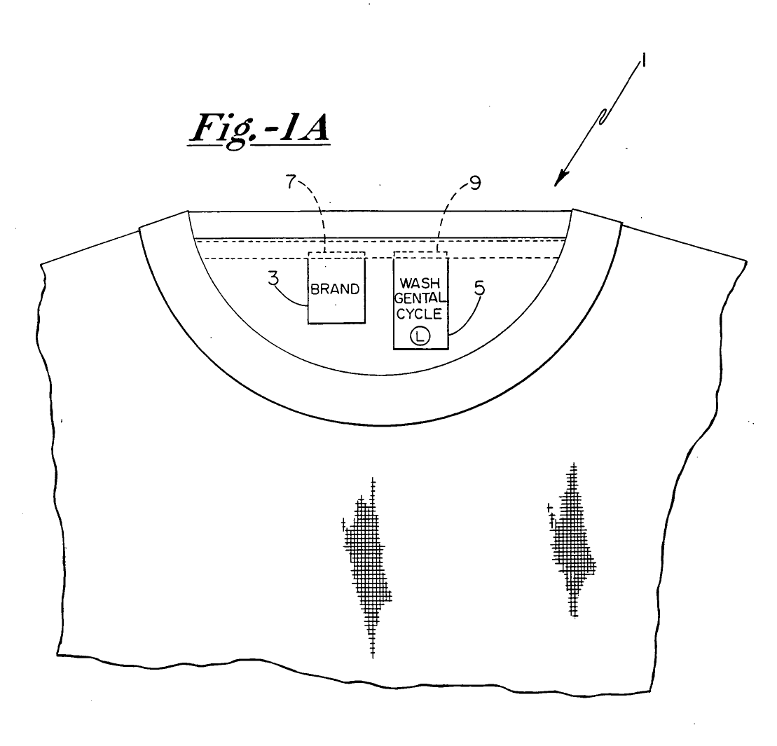

As stated previously, it has become popular practice for companies and other organizations and/or associations to engage the services of after-market garment decorators to decorate various articles of clothing, such as T-shirts, sweatshirts, etc., with company names, logos, and the like. In connection therewith, the decorators will generally purchase an order of plain pre-manufactured garments, such as that shown in FIGS. 1A and 1B, and apply the desired artwork through embroidery or printing techniques well known in the art.

Although garment decorators have heretofore sought to advertise their decorating services by private labeling their garments, such efforts have normally been limited to large orders where economics warrant the expenditure associated with sewn-in private labels. For smaller quantity orders, however, sewing private labels into a garment has been found to be cost prohibitive, thus leaving the decorator with no effective way of advertising their business. It is with this in mind that I have developed a method for adhesively applying private labels to pre-manufactured garments which requires no minimum garment quantity, and which is less time consuming and labor intensive than affixing sewn-in labels.

As shown in FIGS. 1A and 1B, such a pre-manufactured garment 1 typically carries an original manufacturer's brand label 3 that advertises the garment brand, and a care instruction label 5 that provides the consumer with critical information on sizing and care needs for the garment. Such brand and care instruction labels 3 and 5 are nearly always sewn into the garment, and as shown in FIGS. 1A and 1B, are usually secured only along their top edges 7 and 9, respectively. While the brand label 3 and instruction label 5 are shown in side-by-side relation for ease of illustration in FIGS. 1A and 1B, oftentimes the brand and care instruction labels are sewn together into the garment with the brand label 3 overlaying the care instruction label 5.

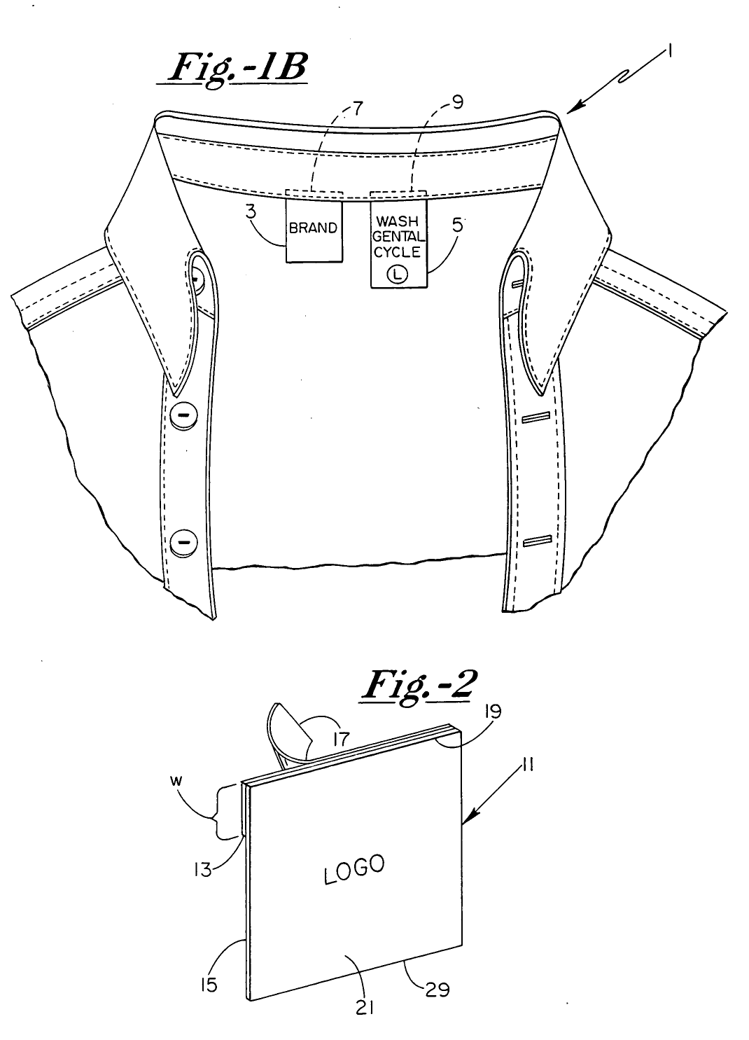

In accordance with the present invention, as shown in FIG. 2, the replacement private label 11 is preferably constructed of a flexible, yet durable, woven fabric material, such as Polyester Taffeta, which is washable and printable with a water-resistant ink. Alternatively, it is also contemplated that other materials, such as Tyvek®, a spunbonded high density material constructed of olefin fibers and manufactured by Dupont, may be used as the substrate for manufacturing the private label 11. While the relative size of the replacement private label 11 may vary, for reasons that will become more apparent hereafter, it is preferred that the width of the private label across top edge 19 thereof closely approximate the corresponding width of the care instruction label 5 carried by the garment. It has been found that a private label of approximately 0.5-1.5 inches in width and 1.0-2.0 inches in length is suitable for most labeling applications.

In order to secure the private label 11 to the garment 1, a pressure-sensitive adhesive layer 13, which is also water-resistant and capable of withstanding repeated wash cycles (i.e., 20-30 home laundering cycles), is applied to the rear face 15 of the private label 11, as shown in FIG. 2. It is deemed desirable that the adhesive 13 utilized be an aggressive water-resistant type tackifier that provides an immediate tack to fabric materials upon applying pressure thereto. It has been found that the TACK-IT brand adhesive utilized by and available through Avery Dennison Retail Information Services, 3511 W. Market Street, Suite 270, Greensboror, N.C., 27403, is particularly well suited for this application.

It will be noted that the thickness of the adhesive strip is actually extremely thin relative to the thickness of label 11, but is shown exaggerated in FIG. 2 for purposes of illustration. Use of such a pressure-sensitive adhesive 13 is preferred in that the labels can be mass produced with a non-stick peel-off backing 17 that may be readily removed to expose the adhesive and simplify application of the private label 11 to the garment. For purposes that will become more evident hereafter, it is intended that the adhesive layer 13 be applied to the rear face 17 of the private label 11 in a transverse strip extending along the top edge 19 thereof. In the preferred embodiment, the width (W) of the adhesive strip 13 is approximately 0.375 inch or less. The opposite or front face 21 of the label 11 is reserved for printing of the decorator's private labeling indicia, such as its company name, logo, and contact information.

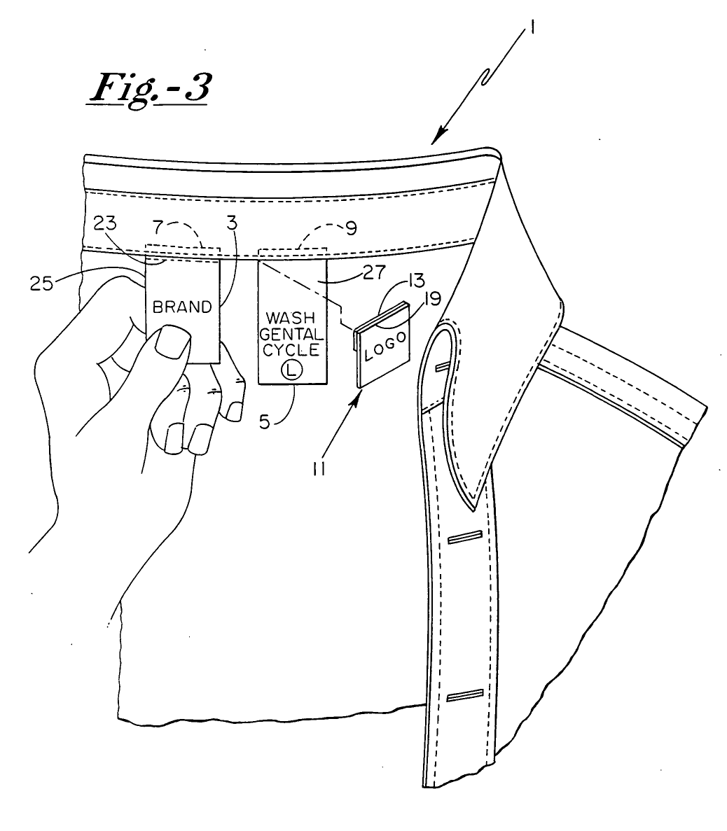

In use, it is intended that the original brand label 3 of the pre-manufactured garment 1 be removed. While it is preferred that this step of the process occur first, it is certainly conceivable that the brand label 3 may be removed subsequent to applying the new private label 11. This step of removing the original brand label 3 may be accomplished through a cutting operation using any employable means for cutting the label material. Alternatively, it is further contemplated that the pre-manufactured garment 1 may be produced with a brand label 3 capable of being torn off. In such case, as shown in FIG. 3, the original brand label 3, which is typically sewn into the garment 1, preferably includes a perforated tear line 23 extending closely adjacent to the sewn-in point of attachment 7 to the garment. Removal of the original brand label may then be effected simply by grasping the free portion 25 of the label and pulling it to separate it from its sewn-in edge 7.

While the original manufacturer's brand label 3 is removed, as shown in FIG. 3, the original care instruction label 5 for the garment 1 is retained. This provides as a durable base to which the new private label 11 may be affixed, since it too is typically sewn into the garment 1, and provides a substantially flat surface to which the private label 11 may adhere. For this reason, it is preferred that the width of the new private label 11 not exceed the width of the care instruction label 5 to which it is secured. As such, since most care instruction labels of pre-manufactured garments are of generally uniform width, the decorator may produce large quantities of standard sized private labels 11 for storage, and use the same printed label on a number of different garments.

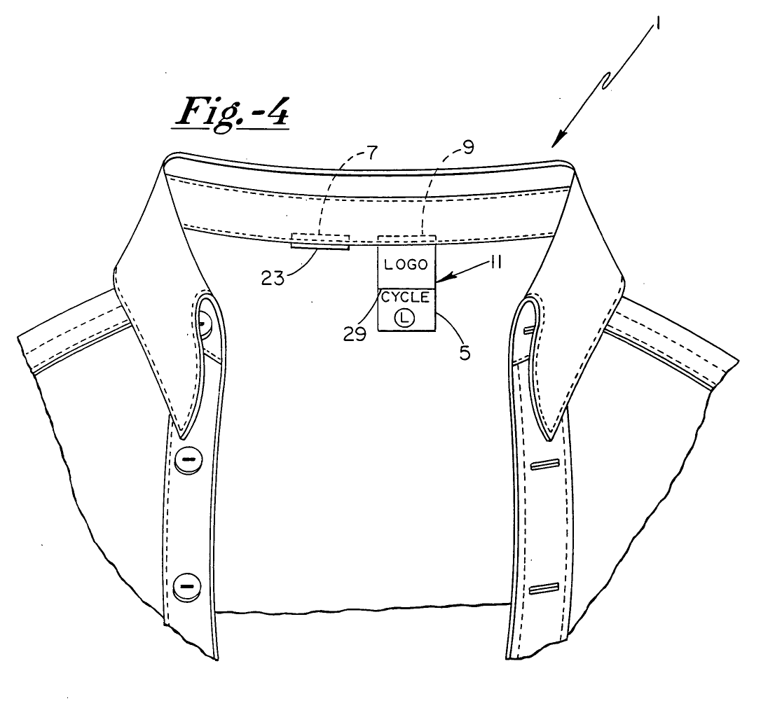

As shown best in FIGS. 3 and 4, when applying the private label 11 to the care instruction label 5, it is important not to obstruct the ability to read the printed size information and/or instructions borne on the care label 5. For this reason, as stated previously, the adhesive layer 13 is preferably applied as a thin layer to the rear face 15 of the private label 11 in a narrow strip (approximately 0.375 inch or less) extending along the top edge 19 thereof. Since the printed information on the care instruction label 5 is generally spaced about the same distance from its top sewn-in edge 9, a non-printed border 27 is defined on the care label 5 which provides adequate space for the adhesive strip 13 to secure.

In order to secure the private label 11 to the care instruction label 5, any non-stick backing material 17 carried by the adhesive strip 13 must first be removed. Then the private label 11 is positioned over the care instruction label 5, as shown in FIG. 3, being careful to align the narrow adhesive strip 13 with the non-printed border region 27 extending adjacent its sewn-in edge 9. With proper positioning, the private label 11 may be firmly pressed against the care instruction label 5, as shown in FIG. 4, thereby securely bonding the two together and essentially creating a “private label” flap that lays over the top of the care instruction label 5. Thus, with relative ease, the free end portion 29 of the private label 11 may be lifted away from the care instruction label 5 for easy access and viewing of the garment's care instructions.

The foregoing process may be used to private label small quantities of garments, as well as large quantities. For small orders, the above process can be implemented by hand, but if the quantity of the order warrants, it is contemplated that auto-handling garment equipment (not shown) could be used to implement the process. In any event, the above process eliminates the cost prohibitive and labor intensive sewing operations required for prior sewn-in private labels, and given the generally standard sizing of care instruction labels, garment decorators may now mass produce their private labels and use the same on multiple job orders and for many different garments. This will significantly increase the ability of the garment decorators to advertise their services, which has heretofore been severely restricted.

It will, of course, be understood that various changes may be made in the form, details, arrangement and proportions of the parts without departing from the scope of the invention which comprises the matter shown and described herein and set forth in the appended claims.

1. A method of private labeling a previously manufactured garment, comprising the steps of:
(a) providing a previously manufactured garment having an original manufacturer's brand label and care instruction label attached thereto;
(b) providing a separate private label manufactured from a washable, printable, durable fabric substrate, said label having opposite sides and carrying on one of said sides a water-resistant adhesive layer, said opposite side thereof bearing printed private-labeling indicia;
(c) removing said original manufacturer's brand label from said garment; and
(d) adhering said private label to said care instruction label by applying said adhesive layer to said care instruction label in such manner as to avoid obstruction of the care instructions printed thereon.

2. The private labeling method of claim 1, wherein said step of providing a previously manufactured garment includes providing said original brand label of said garment with a perforated tear line, and said step of removing said original brand label includes tearing it along said perforated tear line.

3. The private labeling method of claim 1, wherein said step of removing said original brand label includes cutting said original brand label off said garment.

4. The private labeling method of claim 1, wherein said step of providing a separate private label includes the use of a Polyester Taffeta material as said substrate for said private label.

5. The private labeling method of claim 1, wherein said step of providing a separate private label includes the use of a woven fabric as said substrate for said private label.

6. The private labeling method of claim 1, wherein said step of providing a separate private label includes the use of a spunbonded high density material made of olefin fibers as said substrate for said private label.

7. The private labeling method of claim 1, wherein said step of providing a separate private label utilizes a non-stick backing material applied over said adhesive layer that is removable prior to applying said adhesive layer to said care instruction label.

8. The private labeling method of claim 1, wherein said step of providing a separate private label includes forming said adhesive layer as an adhesive strip located along a peripheral edge of said private label.

9. The private labeling method of claim 1, wherein said step of providing a separate private label further comprises the steps of:
(e) providing said private label with a top edge having a dimension approximating the width of said care instruction label; and
(f) affixing said adhesive layer only along a portion of said private label adjacent to said top edge thereof.

10. The private labeling method of claim 1, further comprising the steps of:
(e) providing said adhesive layer with an exposed removable non-stick backing; and
(f) removing said non-stick backing from said adhesive layer prior to adhering said private label to said care instruction label.

11. A method of private labeling a previously manufactured garment, comprising the steps of:
(a) providing a previously manufactured garment having a brand label and care instruction label attached thereto, wherein said care instruction label has care instructions printed thereon in spaced relation to an outer non-printed border portion thereof;
(b) providing a separate private label manufactured from a durable flexible woven polyester fabric that is washable and printable, said private label having opposing front and rear surfaces confined by a peripheral edge, said rear surface carrying an pressure-sensitive adhesive strip adjacent at least a portion of said peripheral edge, and said front surface bearing printed private-label indicia;
(c) removing said brand label from said garment;
(d) placing said private label over said care instruction label with said rear surface facing same, and positioning said private label such that said adhesive strip aligns with said non-printed border portion thereof; and
(e) adhering said private label to said care instruction label by pressing said adhesive strip against said non-printed border portion thereof, thereby avoiding obstruction of said care instructions printed thereon.

12. The private labeling method of claim 11, wherein said step of providing a previously manufactured garment includes providing said brand label of said garment with a perforated tear line, and said step of removing said brand label includes tearing it along said perforated tear line.

13. The private labeling method of claim 11, wherein said step of providing a separate private label utilizes a non-stick backing material applied over said adhesive strip that is removable prior to applying said adhesive strip to said care instruction label.

14. The private labeling method of claim 11, wherein said step of providing a separate private label further includes making said peripheral edge portion which carries said adhesive strip of the approximate dimensions of said non-printed border portion of said care instruction label to which it is adhered.

20. A privately labeled garment prepared by a process comprising the steps of:
(a) providing a previously manufactured garment having an original manufacturer's brand label and care instruction label attached thereto;
(b) providing a separate private label manufactured from a washable, printable, durable fabric substrate, said label having opposite sides and carrying on one of said sides a water-resistant adhesive layer, said opposite side thereof bearing printed private-labeling indicia;
(c) removing said original manufacturer's brand label from said garment; and
(d) adhering said private label to said care instruction label by applying said adhesive layer to said care instruction label in such manner as to avoid obstruction of the care instructions printed thereon.

21. A privately labeled garment prepared by a process comprising the steps of:
(a) providing a previously manufactured garment having a brand label and care instruction label attached thereto, wherein said brand label of said garment includes a perforated tear line extending adjacent its attachment to said garment;
(b) providing a separate private label manufactured from a washable, printable, durable fabric substrate, said label having opposite sides and carrying on one of said sides a water-resistant adhesive layer, said opposite side thereof bearing printed private-labeling indicia;
(c) removing said brand label from said garment by tearing said brand label along said tear line; and
(d) adhering said private label to said care instruction label by applying said adhesive layer to said care instruction label in such manner as to avoid obstruction of the care instructions printed thereon.
